(19) United States
(12) Patent Application Publication
(10) Pub. No.: US 2015/0347363 A1
(43) Pub. Date: Dec. 3, 2015

(54) System for Communicating with a Reader

(71) Applicant: Paul Manganaro, Coopersberg, PA (US)

(72) Inventor: Paul Manganaro, Coopersberg, PA (US)

(21) Appl. No.: 14/291,259

(22) Filed: May 30, 2014

(51) Int. Cl. G06F 17/24; G06F 17/21

(52) U.S. Cl. CPC G06F 17/24; G06F 17/212

(57) ABSTRACT

A system for conveying a story using an electronic reader includes a screen showing multiple areas with text. Different portions of text are associated with different characters and a text portion associated with a particular character is given a unique visual tagging associated with that character.

### BACKGROUND

Electronic readers, tablets, and computer screens present creative people with new ways to tell stories. Yet, when a book is presented electronically, these devices simply convert text from the written page to the screen.

Thus, when users read a book on their Kindle or iPad, the only upgrades they have over paper books are the ability to change text font and size and a search function, and these are user controls, and do not relate to the story-tellers having more flexibility in the way they tell their story.

Written text passages may traditionally use four descriptive elements: 1. Quotation marks indicating portions of text are spoken words or thoughts. 2. Phrases identifying which character is associated with a particular section of quoted text such as: JOHN SAID or MARY ASKED. 3. The emotional state of the person's quoted text such as: JOHN SAID HAPPILY or MARY ASKED INQUISITIVELY. 4. Finally, phrases indicating whether quoted text has been spoken with the phrase JOHN SAID or whether the quoted text is a thought with the phrase: JOHN THOUGHT.

These four examples may contradict the conventional “show, don't tell” rule of writing that encourages authors to creatively describe elements of a story rather than to tell or list them. The four descriptive elements oftentimes detract from a story due to their “telling” nature.

### SUMMARY OF THE EMBODIMENTS

A system for conveying a story using an electronic reader includes a screen showing multiple areas with text. Different portions of text are associated with different characters and a text portion associated with a particular character is given a unique visual tagging associated with that character.

### BRIEF DESCRIPTION OF THE DRAWINGS

FIG. 1 shows one embodiment of the invention.

FIG. 2 shows another embodiment of the invention.

FIG. 3 shows another embodiment of the invention.

FIG. 4 shows another embodiment of the invention.

FIG. 5 shows a logical flowchart according to an embodiment of the invention.

FIG. 6 shows a sample dialog.

### DETAILED DESCRIPTION OF THE EMBODIMENTS

The invention described herein takes advantage of the flexibility of the digital medium to convey information in a way that was not possible using paper books. Therefore, in order to present only “showing” or descriptive text, each or more of these previously listed four examples of “telling” including quotation marks, character identification and emotional explanations may be eliminated by the following.

1. Highlighting each character's quoted text in color renders quotation marks unnecessary.

2. Assigning a different color unique to each character renders the use of phrases identifying the character unnecessary.

3. An avatar unique to each character with appropriate facial expressions placed before traditionally-quoted text renders the use of descriptive phrases of emotional state unnecessary.

4. A full-bodied avatar unique to each character with appropriate facial expressions as well as body language renders the use of descriptive phrases distinguishing the difference between JOHN THOUGHT and JOHN SAID, renders the use terms such as “thought” or “said” unnecessary.

Through the use of these four basic elements, an author can present storytelling in a new manner free from unnecessary, traditional encumbrances.

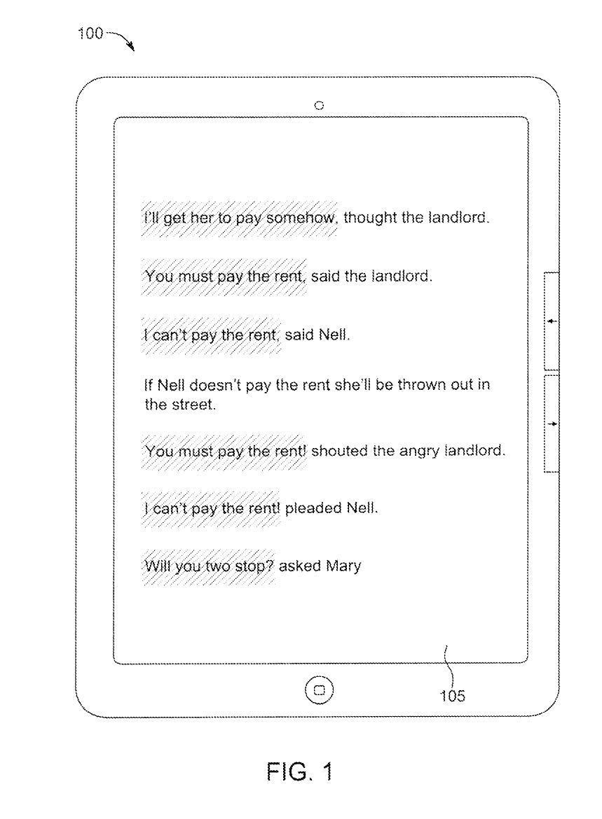

FIG. 1 shows an electronic reader 100 such as a Kindle, Nook, or iPad. The electronic reader 100 has a screen 105 that shows a sample dialog with 3 characters or speakers: a landlord, Nell, and Mary. There is also a narrator character voice. As shown in FIG. 1, all of the character dialog is shown as highlighted in the same color or tone. Note that dialog, as used herein, includes internal dialog or thoughts such as the landlord's first thought.

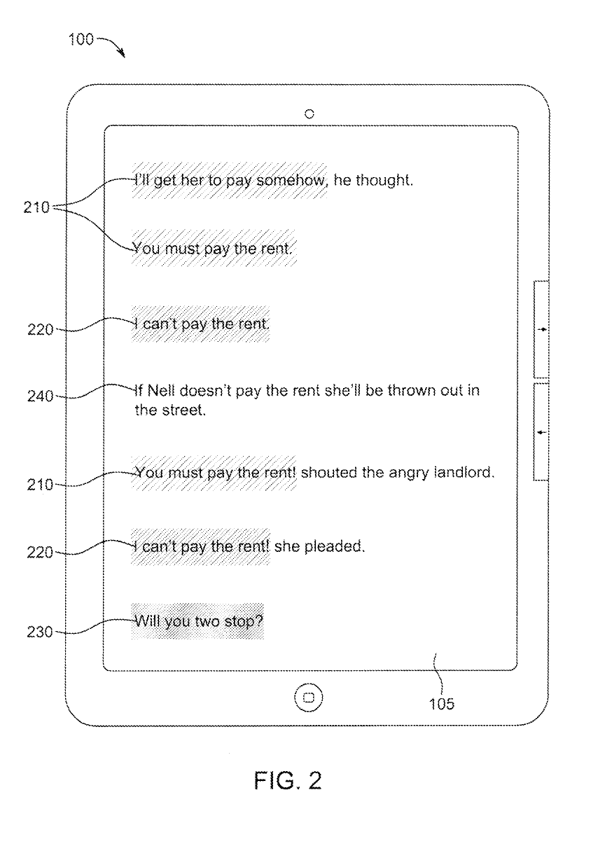

As shown in FIG. 2, instead of interjecting “said the landlord” and other speaker indicators, different speakers here are indicated by different highlighting. The landlord's text portion of dialog (and internal dialog) 210 is visually tagged with a lighter highlight than Nell's text portion of dialog 220. Mary's dialog 230 is shown as reverse highlight and the narrator's text portion 240 is shown with no highlight.

Obviously other variations on this output are possible. For example, the text could be multicolored for each user, or carry a different font. Larger text could be used to describe a speaker talking at a higher volume. The reader could view a speaker key at any point, on interacting with a user interface (through the touch screen 105) if they needed a reminder about who was speaking.

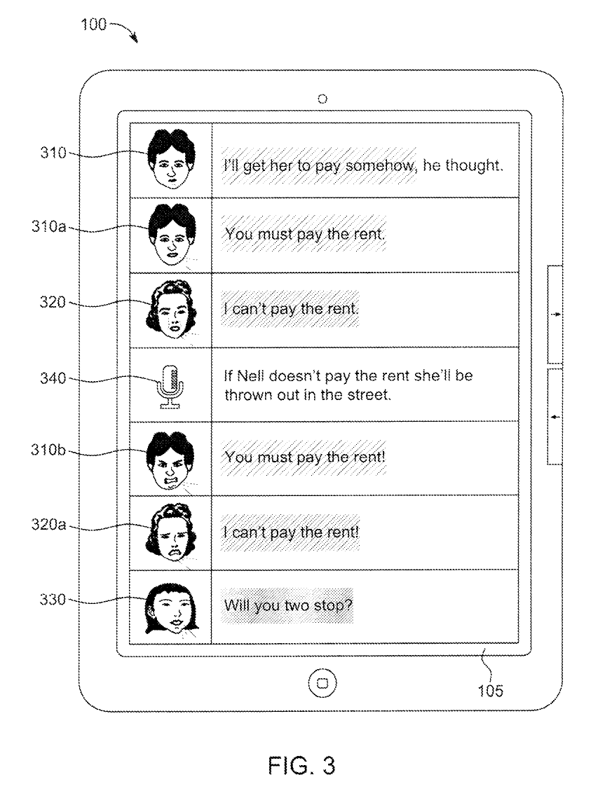

FIG. 3 shows another way to show the output text. In FIG. 3, different character faces or avatars are aligned with the text to show who is talking. The landlord 310, Nell 320, and Mary 330 all have their own faces, with the narrator 340 shown with a microphone. The avatars in FIG. 3 are shown statically with facial expressions that change depending on their projected emotion (the emotion conveyance is optional). The landlord, for example, is shown speaking with image 310a and in anger in image 310b. Nell is shown more agitated in image 320b.

Even further, the avatars need not be static at all, but could be animated in a way that reflects the speakers' emotions and physical conditions. Thus, an injured character who is talking may show active signs of stress.

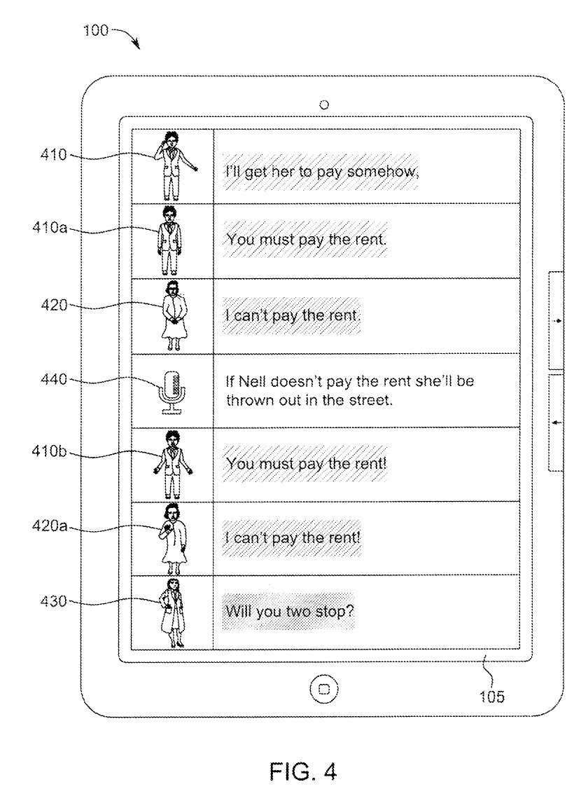

Moreover, the avatars could be more than faces, and include full bodies that are animated in ways that compliment or reflect the text, conveying action or emotion as shown in FIG. 4. In this example, the landlord is first shown thinking 410, then speaking 410a, and finally upset 410b. Nell is shown speaking 420 and upset 420a while the narrator 440 and Mary 430 are also shown.

Within the story computer file itself, each speaker's dialog may be accompanied by a tag to indicate the speaker. That tag may be indexed against text colors, highlights, or avatar options that a user could choose by accessing the electronic reader's user interface. For example, a first reader may find the avatar distracting and instead choose a setting that only uses highlighting. Or such user control may be disabled.

Dialog tagging like this allows for the digital story to return searches by speaker. If, for example, a user wants to see a list of things that the landlord in FIG. 3 said, the user could click on the landlord's avatar through the electronic reader user interface and get a list of only the dialog text portions tagged to the landlord.

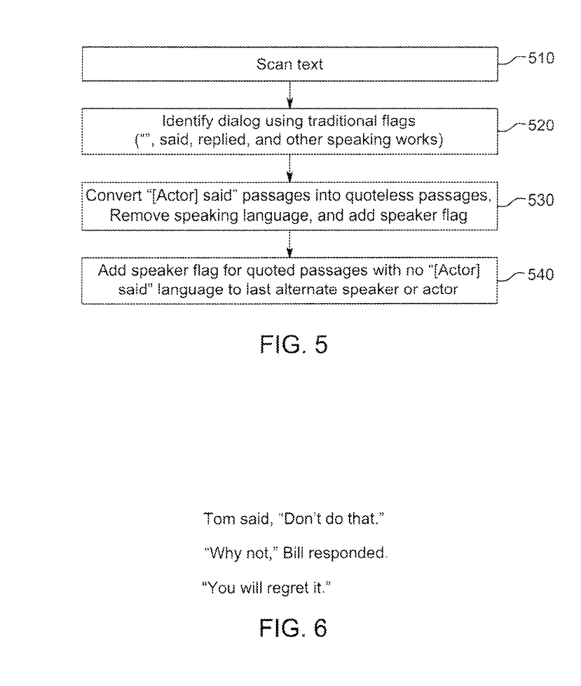

A program could be used to convert traditional dialog into this format as well, by assigning the tagging automatically. Such a program might follow the steps in FIG. 5. For example, step 1 would be to scan the text 510 or otherwise secure a readable and searchable file. In step 2, the program may identify dialog using traditional indicators such as open and close quotation marks and speaking words like “said” and “replied” 520. In step 3, such a program may tag the dialog passages to an individual speaker associated with the passage and remove quotation marks and speaking language such as “Mary said” 530 from the text.

In step 4, the program may go back to review the passages with no clear speaker identified. Often, when two people are speaking in a book, the dialog alternated back and forth with only an occasional identifier. In such a case, the speaker may be found by reviewing alternate speakers through the dialog until one of the alternates has an identifier. For example, a passage may read like is shown in FIG. 6. In such an example, the program may search backwards to alternate speakers in the dialog to identify (and flag) Tom as the original speaker.

Or, a character may be identified, and it's assumed they are the speaker, such as this example:

Tom pushed the alarm. “Let's see how long it takes for the police to arrive.”

In this example, Tom is the speaker but it's not said that he is. Contextually, the program could search for the last known character preceding a quoted passage and assign the dialog to him 540 before removing quotation marks and speaking/internal dialog language.

Another feature that is possible is that by interacting with the text or avatar (selecting the text or avatar), the reader may hear the dialog as if being spoken by a character, allowing the reader to hear the story or read along with it.

Yet other features are possible where certain words, avatars, or paragraphs could be activatable (selectable in a way that a hyperlink may be selected) that plays a video or animates a scene. For example, in a story that talks about mice, a reader may seelct on the word “mice” and animated mice run around the page in, out and around the printed words on the electronic reader. In another example, movies may be incorporated into the text such that a reader may push on the word “runs” in the sentence “Johnny runs away from the dragon” and then an animated scene from a corresponding movie runs on the electronic reader's screen showing a clip from the movie where Johnny is running away from the dragon.

The unanimated features such as highlighting and character avatars could be used in paper books as well.

The previous detailed description is made with reference to the figures. Preferred embodiments are described to illustrate the disclosure, not to limit its scope, which is defined by the claims. Those of ordinary skill in the art will recognize a number of equivalent variations in the description.

1. A system for conveying a story using an electronic reader comprising:
a screen showing multiple areas with text, wherein different portions of text are associated with different characters, wherein a text portion associated with a particular character is given a unique visual tagging.

2. The system of claim 1, wherein the text portion is a portion of dialog.

3. The system of claim 1, wherein the visual tagging includes highlighting the text portion.

4. The system of claim 1, wherein the visual tagging comprises an avatar.

5. The system of claim 4, wherein the avatar comprises a face associated with a character.

6. The system of claim 5, wherein the face is animated, wherein the animation changes depending on the text portion or story.

7. The system of claim 4, wherein the avatar comprises an animation of an entire body of a character.

8. The system of claim 7, wherein the animation changes depending on the text portion or story.

9. The system of claim 1, further comprising a user interface that allows a user to select different types of visual tagging.

10. The system of claim 1, further comprising a user interface that allows a user to hear an audible reading of the text associated with characters and narrators by making a selection.

11. The system of claim 1, further comprising a user interface that allows a user to select the character and view text portions associated with that character.

12. A method of telling a story comprising:
presenting the story on a screen;
showing multiple areas with text on the screen, wherein different portions of text are associated with different characters; and
providing a unique visual tagging to a text portion associated with a particular character.

13. The method of claim 12, wherein the text portion is a portion of dialog.

14. The method of claim 12, wherein the visual tagging includes highlighting the text portion.

15. The method of claim 12, wherein the visual tagging comprises an avatar.

16. The method of claim 15, wherein the avatar comprises a face associated with a character.

17. The method of claim 16, wherein the face is animated.

18. The method of claim 17, wherein the animation changes depending on the text portion or story.

19. The system of claim 12, further comprising a user interface that allows a user to select different types of visual tagging.

20. A method of converting a traditional work of fiction to a work of fiction with visual tagging comprising the steps:
providing a story in a readable file format;
identifying dialog using traditional indicators such as open and close quotation marks and speaking words;
tagging dialog to an individual speaker associated with the dialog; and
removing the quotation marks and speaking words.
